(19) United States
(12) Patent Application Publication
(10) Pub. No.: US 2006/0237878 A1
(43) Pub. Date: Oct. 26, 2006

(54) Cold-shrink marker sleeve

(75) Inventor: Krishnakant P. Vora, Round Rock, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/474,656

(22) Filed: Jun. 26, 2006

Related U.S. Application Data
(62) Division of application No. 10/806,811, filed on Mar. 23, 2004.

(51) Int. Cl. B29C 35/08

(52) U.S. Cl. 264/400; 264/132

(57) ABSTRACT

A tubular article that includes a compositional mixture of an elastomer, a pigment, and a energy beam absorber. The tubular article further includes indicia formed on an outer surface of the tubular article. The indicia is formed by expanding the tubular article from a relaxed state to an expanded state, marking the outer surface with a laser, and allowing the tubular article to cold shrink from the expanded state.

### CROSS-REFERENCE TO RELATED APPLICATION(S)

This application is a divisional of U.S. Ser. No. 10/806,811, filed Mar. 23, 2004, the disclosure of which is herein incorporated by reference.

The co-pending patent application filed on Mar. 23, 2004, U.S. Ser. No. 10/806,842, entitled “NBC-Resistant Composition”, is incorporated herein by reference in its entirety.

### FIELD OF THE INVENTION

The present invention relates to marking of articles. In particular, the present invention relates to laser marking of elastomeric articles in expanded states to provide identification for items used with the elastomeric articles.

### BACKGROUND OF THE INVENTION

Identification markings are often applied to articles to serve a variety of informational purposes. For example, the markings may provide information regarding product names, manufacturer names, bar codes, serial numbers, batch numbers, and expiration dates. To better serve such purposes, the marks desirably are visually legible, durable, and easy to manufacture.

In the past, identification marks were frequently applied to articles using ink printing technology of one sort or another. Ink markings were applied to a label with an adhesive coating, or were applied directly to an exterior surface of the article. In either situation, it was desirable that the markings, as applied, exhibited contrasting colors with the surrounding non-marked surface to increase visual legibility of the markings. However, a common problem associated with ink printing was environmental conditions generally weathered printed ink markings over time. For example, an ink mark on a surface, upon exposure to heat and abrasive conditions, typically degraded and wore away. This prevented the ink marking from providing visually legible information over the long term.

In recent years, laser technology has been increasingly used to apply identification marks to articles. The mark may be formed by a laser-induced chemical reaction on the surface of the article, where the mark visibly contrasts non-marked portions of the surface. Alternatively, laser marking may entail a surface layer removal by laser ablation, which leaves an exposed underlying surface that visibly contrasts with the surface layer. Laser marking generally presents an important advantage over ink marking since laser markings are often more resistant to environmental conditions.

Nonetheless, conventional laser marking methods require precise and consistent laser beam operation. Otherwise, under-marking or over-marking may occur. Under-marking occurs when the laser beam causes insufficient chemical reaction or ablation, which correspondingly may limit the visual legibility of the marking. Alternatively, over-marking occurs when the laser beam causes excessive chemical reaction or ablation, which may also limit the visual legibility of the marking, and may potentially damage the article. As such, there is a continuing need for a method of marking articles that yields visually legible, durable, and easy to manufacture markings.

### BRIEF SUMMARY OF THE INVENTION

The present invention relates to a tubular article that is based upon an elastomer, a pigment, and an energy beam absorber. The tubular article is in an expanded state and is capable of being placed in a relaxed state. The tubular article further includes indicia formed on an outer surface of the tubular article by a focused energy beam. The indicia, when in the form of alphanumeric characters, is legible to an eye of an individual located at least about 36 centimeters away from the indicia when the tubular article is in the expanded state and in the relaxed state.

The present invention further relates to a method of marking a tubular article that has an outer surface. The method includes forming the tubular article, where the tubular article includes an elastomer, a pigment, and an energy beam absorber. The tubular article is expanded from a relaxed state to an expanded state, and indicia are formed on the outer surface in the expanded state with a focused energy beam. The tubular article is then allowed to cold shrink from the expanded state.

The tubular article and the method of marking the tubular article provide indicia that are visually legible, durable, and easy to manufacture.

### BRIEF DESCRIPTION OF THE DRAWINGS

The patent or application file contains at least one drawing executed in color. Copies of this patent or patent application publication with color drawing(s) will be provided by the Patent Office upon request and payment of the necessary fee.

FIG. 1 is a perspective view of a marker sleeve of the present invention in use with a cable.

FIG. 2 is a perspective view of a marker sleeve of the present invention in a relaxed state, prior to expansion.

FIG. 3 is a perspective view of a marker sleeve of the present invention in an expanded state on a core.

FIG. 4 is another perspective view of a marker sleeve of the present invention in an expanded state on a core.

FIG. 5 is a perspective view of a marked marker sleeve of the present invention in an expanded state on the core, with an associated cable.

FIG. 6 is a perspective view of a marker sleeve of the present invention that is partially located on a core and partially located on a cable.

FIG. 7 is a photographic view of a marked marker sleeve of the present invention in an expanded state on a core.

FIG. 8 is a photographic view of a marked marker sleeve of the present invention that is partially located on a core.

FIG. 9 is a photographic view of a marked marker sleeve of the present invention in a relaxed state following cold shrinkage from an expanded state.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments may be devised by those skilled in the art, which fall within the scope and spirit of the principles of the invention. The figures may not be drawn to scale. Like reference numbers have been used throughout the figures to denote like parts.

### DETAILED DESCRIPTION

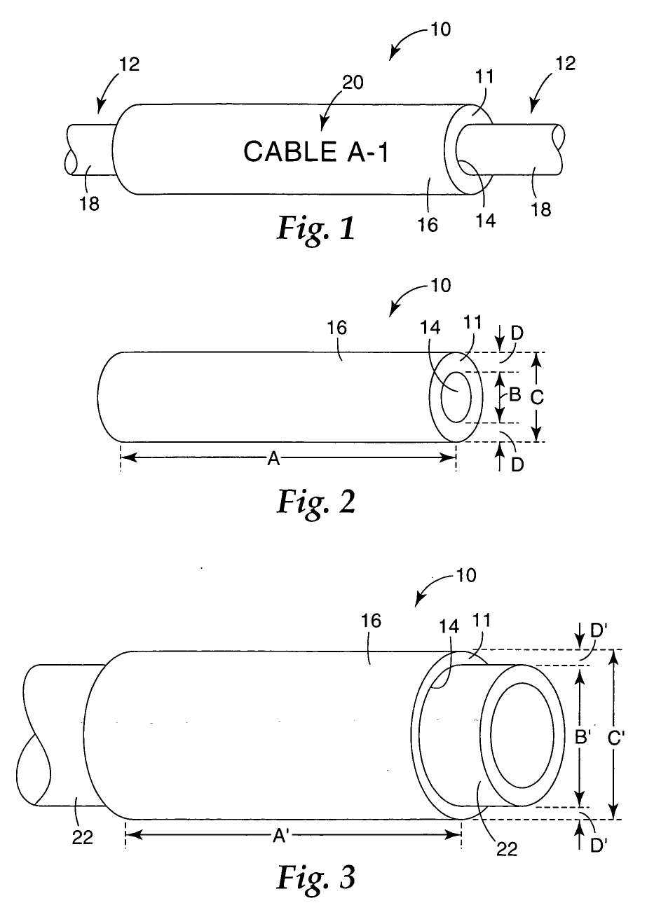

The present invention encompasses a marker sleeve 10, as depicted in use on a cable 12 in FIG. 1. The marker sleeve 10 is a tubular article that provides information for, or about, a transmission or distribution run, such as electric and telephone cables, wire, fluid-carrying piping, and conduits. The cable 12 is an example of such a transmission or distribution run, although the marker sleeve 10 may be used on any transmission or distribution run.

As illustrated, the marker sleeve 10 includes a radial wall 11, an inner surface 14, and an outer surface 16, where the inner surface 14 extends around, faces, and is typically in contact with an outer surface 18 of the cable 12. Indicia 20, which is information marked by a focused energy beam, is located on the outer surface 16. A focused energy beam refers to a directionally focused emission of radiation, such as a laser beam. The indicia 20 may be a single mark or a plurality of marks, and may include a variety of textual (i.e., alphanumeric) or graphical characters, symbols, and the like. The indicia 20 may also be or include machine-readable indicia, such as bar codes. The indicia 20 is formed by expanding the marker sleeve 10 from a relaxed state, marking the outer surface 16 (in the expanded state) with a focused energy beam, and allowing the marked marker sleeve 10 to cold shrink back toward the relaxed state. The term “cold shrink” is referred to herein as the capability of the marker sleeve 10 to shrink from an expanded state toward a relaxed state at temperature less than about 50° C. As the marker sleeve 10 cold shrinks toward the relaxed state, the indicia 20 retain a high level of visual legibility.

While depicted in FIG. 1 as a single tubular article, the marker sleeve 10 of the present invention may include a variety of shaped features, such as multiple-branched tubular articles (i.e., multiple entrances and exits). The indicia 20 on the marker sleeve 10 as a multiple-branched tubular article may be formed by separately expanding, marking, and cold shrinking each branched portion.

The marker sleeve 10 is generally derived from a compositional mixture of an elastomer, a pigment, and an energy beam absorber, such as a laser beam absorber. The elastomer allows the marker sleeve 10 to expand from the relaxed state to the expanded state without breakage or cracking, and also allows the marker sleeve 10 to cold shrink from the expanded state back toward the relaxed state. The pigment generally provides a base color to the marker sleeve 10, including a base color of the outer surface 16. Similarly, upon heating by a focused energy beam, the energy beam absorber generally provides a contrasting color to the indicia 20. For high visual legibility of the indicia 20, it is desirable to use a pigment and an energy beam absorber that provide a high contrast between the base color of the outer surface 16 and the contrasting color of the indicia 20. For example, a bright yellow or white color for the outer surface 16 may be suitable when the energy beam absorber provides a dark gray or black color for the indicia 20. Alternatively, a dark color for the outer surface 16 may be suitable if the energy beam absorber provides a light-color for the indicia 20. In either case, the high color contrast between the base color and the contrasting color increases the visual legibility of the indicia 20.

All concentrations herein are expressed in weight percent, unless otherwise stated. Suitable component concentrations in the compositional mixture of the marker sleeve 10 range from about 25.0% to about 90.0% of the elastomer, from about 0.5% to about 10.0% of the pigment, and from about 0.01% to about 5.0% of the energy beam absorber, based on the total compositional weight of the marker sleeve 10. Particularly suitable component concentrations in the compositional mixture of the marker sleeve 10 range from about 25.0% to about 40.0% of the elastomer, from about 1.0% to about 5.0% of the pigment, and from about 0.01% to about 3.0% of the energy beam absorber, based on the total compositional weight of the marker sleeve 10.

To form the marker sleeve 10 with the indicia 20 located on the outer surface 16, the compositional mixture of the marker sleeve 10 is uniformly mixed, extruded, and cross-linked, as discussed below, to provide the marker sleeve 10 as depicted in FIG. 2. FIG. 2 is a perspective view of the marker sleeve 10 in a relaxed state prior to expansion and marking. When the marker sleeve 10 is in the relaxed state, the radial wall 11 has a longitudinal length A, an inner diameter B, an outer diameter C, and a layer thickness D. The longitudinal length A and the inner diameter B will vary based upon individual needs, such as the dimensions of the cable 12. The inner diameter B desirably is adequate to present a sealed fit around the surface 18 of the cable 12 to at least prevent the marker sleeve 10 from sliding along the cable 12.

The outer diameter C is generally determined by the inner diameter B and the layer thickness D, where the layer thickness D is substantially uniform around and along the marker sleeve 10. The layer thickness D is desirably thin enough to allow the marker sleeve 10 to readily expand from the relaxed state, while also thick enough so laser marking does not burn through the radial wall 11 of the marker sleeve 10, when the marker sleeve 10 is in the expanded state. Suitable layer thicknesses D of the marker sleeve 10 in the relaxed state range from about 0.76 millimeters (mm) (30 mils) to about 2.29 mm (90 mils). Particularly suitable layer thicknesses D of the marker sleeve 10 in the relaxed state range from about 1.27 mm (50 mils) to about 1.78 mm (70 mils).

After the marker sleeve 10 is formed, the marker sleeve 10 is cross-sectionally expanded from the relaxed state to the expanded state. Herein, the terms “expanded”, “expansion”, “expanded state”, and the like, refer to a cross-sectional expansion that increases the inner diameter B and the outer diameter C, as opposed to a longitudinal expansion that would increase the longitudinal length A. Referring to FIG. 3, which depicts the marker sleeve 10 of FIG. 2 in the expanded state around a core 22, the marker sleeve 10 may be expanded and placed onto the core 22 in any conventional manner. The core 22 may be any type of rigid device for retaining the marker sleeve 10 in the expanded state, such as a rigid, hollow, plastic tube. When the marker sleeve 10 is in the expanded state, as depicted in FIG. 3, the radial wall 11 includes a longitudinal length A′, an inner diameter B′, an outer diameter C′, and a layer thickness D′. Due to the expansion, the inner diameter B′ and the outer diameter C′ are greater than the inner diameter B and outer diameter C, respectively. The extent of the diameter increases from B to B′ and from C to C′ depends on the extent to which the marker sleeve 10 is expanded. Suitable expansion of the marker sleeve 10 generally include increases from the inner diameter B to the inner diameter B′ that range from about 150% to about 300%. Particularly suitable expansion ranges of the marker sleeve 10 include increases from the inner diameter B to the inner diameter B′ that range from about 200% to about 250%.

The expansion of the marker sleeve 10 also causes the layer thickness D′ to be thinner than the layer thickness D. The extent of the difference between the layer thickness D and the layer thickness D′ depends on the particular composition of the marker sleeve 10 and the extent to which the marker sleeve 10 is expanded. As previously discussed, the layer thickness D′ of the marker sleeve 10, in the expanded state, should be thick enough to prevent the laser marking from burning entirely through the radial wall 11 of the marker sleeve 10. The expansion of the marker sleeve 10 also typically causes the longitudinal length A′ of the expanded marker sleeve 10 to be shorter than the longitudinal length A of the marker sleeve 10 in the relaxed state.

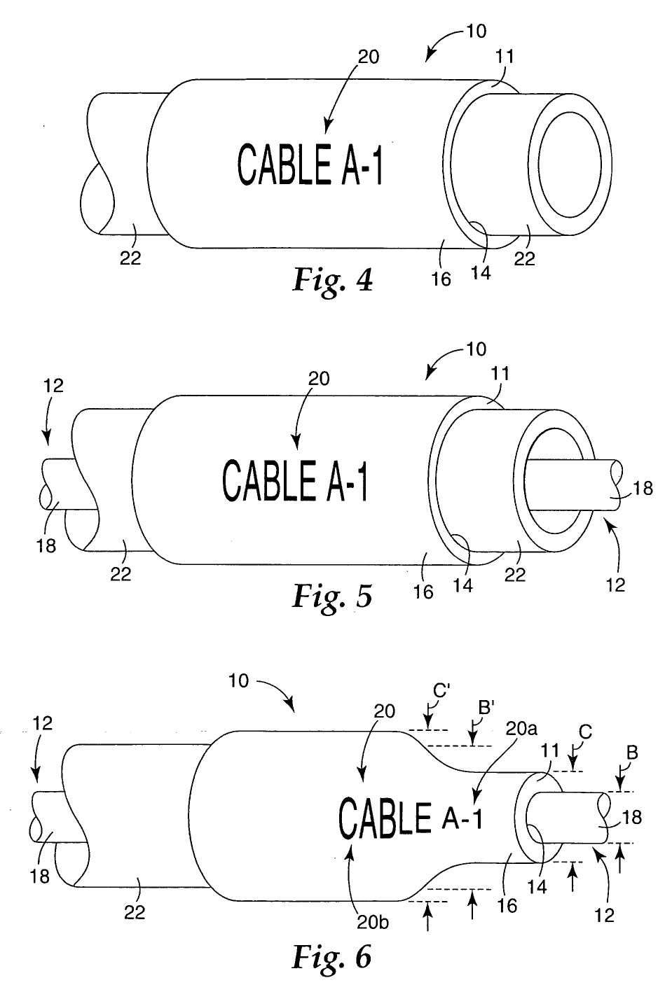

FIG. 4 is a perspective view of the marker sleeve 10 in the expanded state and on the core 22, after the outer surface 16 is marked to form the indicia 20. Marking of the outer surface 16 while the marker sleeve 10 is in the expanded state increases the surface area of the marked portion of the outer surface 16. As such, larger indicia 20 may be formed. The size differences of the indicia 20 are best illustrated by comparing the indicia 20 depicted in FIGS. 1 and 4. The indicia 20 depicted in FIG. 4, where the marker sleeve 10 is in the expanded state, exhibits taller, narrower type face heights in the circumferential direction of the marker sleeve 10 than the indicia 20 depicted in FIG. 1, where the marker sleeve 10 is in the relaxed state. Laser marking the marker sleeve 10 in the relaxed state would increase the required accuracy and consistency to create visibly legible indicia. As such, the expansion of the marker sleeve 10 prior to marking allows formation of indicia 20 that exhibit a higher degree of detail and resolution, and thereby reduces the marking precision required to produce the indicia 20 that is highly legible when the marker sleeve 10 is in the relaxed state.

The indicia 20 are formed by marking the outer surface 16 of the marker sleeve 10 with a focused energy beam, such as a laser beam. In one embodiment, the indicia 20 may be formed by exposing the outer surface 16 of the marker sleeve 10 to laser generated radiation (i.e., a laser beam) at an energy level sufficient to cause charring of selected portions of the outer surface 16. The charring is created when the heat of the focused energy beam transfers from the energy beam absorber to initiate a chemical reaction of the polymers. The chemical reaction alters the color of the outer surface 16 at the location of the charring, which creates a dark contrasting mark that visibly contrasts with the remaining lighter base colored portions of the outer surface 16.

Alternatively, in a second embodiment, different laser beam settings may be used to foam the outer surface 16 in the course of forming the indicia 20. This is useful to create light-colored markings on the outer surface 16. The foaming, like the aforementioned charring, is also created by a chemical reaction of the polymers upon heating with a focused energy beam. However, the chemical reaction creates a light-colored mark at the location of the foaming, which visibly contrasts with the remaining dark-colored portions of the outer surface 16. In either embodiment, the focused energy beam is moved about the outer surface 16 as needed to create the desired textual characters, graphics, symbols, and the like, of the indicia 20.

An example of a suitable laser system for creating such markings in the outer surface 16 of the radial wall 11 is a Nd:YAG laser, which is commercially available under the trade designation “Scriba” from Electrox of Indianapolis, Ind. However, other focused energy beam systems may also be employed, such as CO₂ lasers and masers. The indicia 20 may be made in one or two passes of the laser beam, or in additional passes of the laser beam if a somewhat wider field of the indicia 20 is desired. Multiple laser beam passes may also be used, either from multiple lasers or via laser beam splitting and focusing techniques. Suitable set distances of the laser system head to the outer surface 16 of the marker sleeve 10 include ranges from about 2 centimeters (cm) to about 31 cm. Such ranges are generally determined by the laser focus point of the system. For example, an Nd:YAG laser system may exhibit a set distance of the laser system head to the outer surface 16 of the marker sleeve 10 of 18.3 cm (7.2 inches).

The settings of the laser system are selected so the marker sleeve 10 is adequately marked on the outer surface 16 (i.e., to prevent under-marking), but without excessively heating or softening (i.e., to prevent over-marking) underlying portions of the marker sleeve 10. It is important that the structural integrity of the radial wall 11 of the marker sleeve 10 is maintained to avoid the potential for tearing the radial wall 11. The laser beam energy pulses should not adversely affect the ability of the marker sleeve 10 to be securely retained on the cable 12. Examples of suitable settings for a Nd:YAG laser system include power settings ranging from about 55 watts to about 70 watts, rates of marking ranging from about 5 centimeters/minute to about 7 centimeters/minute, and frequencies ranging from about 1 wave peak per second to about 10 wave peaks per second.

Laser marking enables significant flexibility for production of identification markings (i.e., indicia 20), both in terms of the information being marked, and in terms of production lead times and set up costs. The flexibility of laser marking allows individualized tailoring of the indicia 20 on the marker sleeve 10 to specific customer requests, or specific marketing goals. The laser markings may be easily and quickly changed from one marker sleeve 10 to a different marker sleeve 10. For example, digital information regarding markings desired by a customer may be input into a computer program, which directs the laser system to produce the laser markings. This allows for quick start-ups and on-demand modifications to the laser markings.

After marking, the marker sleeve 10 with the indicia 20 is removed from the core 22 onto the cable 12. This may be accomplished by any suitable conventional technique. In one embodiment, as depicted in FIGS. 5 and 6, the cable 12 may be inserted within the hollow portion of the core 22, before or after laser marking. The cable 12 may be cross-sectionally centered within the core 22 by guide fingers (not shown) contained within the core 22. After the cable 12 is inserted within the core 22, the marker sleeve 10 is conveyed from the core 22 onto the cable 12. The conveyance may be accomplished in a variety of manners, such as by sliding the marker sleeve 10 from the core 22 onto the cable 12, or by collapsing and removing the core 22 to allow the marker sleeve 10 to encompass the cable 12.

As depicted in FIG. 6, when the marker sleeve 10 is removed from the core 22, the marker sleeve 10 cold shrinks from the expanded state toward the relaxed state. Whether or not the marker sleeve 10 reaches the relaxed state depends on the diameter of the cable 12. As depicted in FIG. 6, the cable 12 has a diameter that allows the marker sleeve 10 to substantially return to the relaxed state, as noted by the inner diameter B and the outer diameter C. Alternatively, however, the inner diameter B of the marker sleeve 10 in the relaxed state may be slightly smaller than the diameter of the cable 12. This alternative prevents the marker sleeve 10 from fully cold shrinking back to the relaxed state, and thereby provides a snug and secure fit of the marker sleeve 10 around the cable 12.

The cross-sectional shrinkage of the marker sleeve 10 also shrinks the indicia 20, as shown by comparing indicia portions 20a, 20b. When a portion of the marker sleeve 10 shrinks, the corresponding portion of indicia 20 (i.e., the indicia portion 20a) also shrinks, while the portion of indicia 20 that remains in the expanded state supported on the core 22 (i.e., the indicia portion 20b) remains larger. When the marker sleeve 10 shrinks, the indicia portion 20a retracts with the cross-sectional dimensions that decrease from the inner diameter B′ and the outer diameter C′. However, the retraction of the indicia portion 20a and consequent reduction of the dimensions of the indicia 20 does not render the indicia 20 illegible. For example, a portion of the indicia 20 that is defined by a straight line when the marker sleeve 10 is in the expanded state will remain defined by a straight line when the marker sleeve 10 substantially cold shrinks back toward the relaxed state. Moreover, the reduction of the dimensions of the indicia 20 effectively increases the print density of the indicia 20. As such, the indicia portion 20a remains visually legible when the marker sleeve 10 is substantially in the relaxed state, to provide information regarding the cable 12.

The marker sleeve 10 desirably provides information markings (i.e., indicia 20) that conform to the U.S. Department of Defense Standard Practice MIL-STD-130K (2000), entitled “Identification Marking of U.S. Military Property”, and the SAE AS81531 Aerospace Standard of SAE International, Warrendale, Pa., entitled “Marking of Electrical Insulating Materials”, each of which is incorporated herein by reference in its entirety. The SAE AS81531 Aerospace Standard §3.2.2 provides examples of suitable type face heights in the circumferential direction of the marker sleeve 10 in the relaxed state, which include type-face heights ranging from about 1.6 mm for an outer diameter C of about 0.9 mm to about 4.5 mm for an outer diameter C of about 25 mm.

Upon complete removal from the core 22, the marker sleeve 10 cold shrinks around the cable 12, as depicted in FIG. 1. The indicia 20 located on the outer surface 16 sufficiently contrasts in color with the outer surface 16 to enable visual human detection of the indicia 20 and/or optical machine-readable detection of the indicia 20.

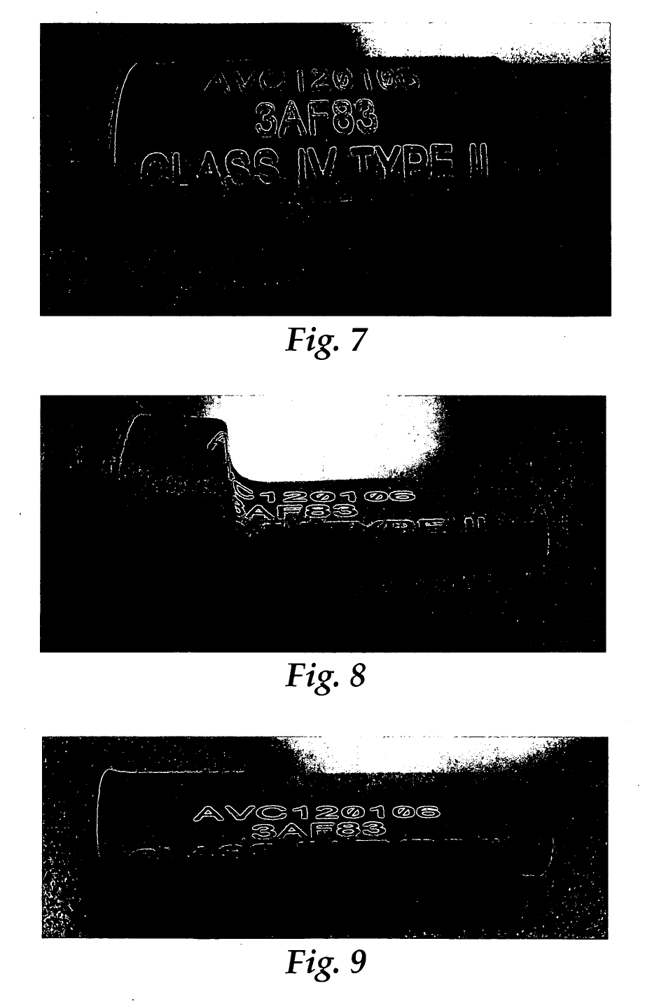

FIGS. 7-9 are photographs of the marker sleeve 10 of the present invention. FIG. 7 depicts the marker sleeve 10 in an expanded state around the core 22 after marking, as described in FIG. 4. Referring to the dimensional labels depicted in FIG. 4, the marker sleeve 10 in FIG. 7 has a longitudinal length A′ of 5.5 centimeters (cm) and an inner diameter B′ of 3 cm. FIG. 8 depicts the marker sleeve 10 being removed from the core 22, as described in FIG. 6, without the cable 12. Referring to the dimensional labels depicted in FIG. 6, the marker sleeve 10 in FIG. 8 has inner diameter B′ of 3 cm, an inner diameter B of 1.3 cm, and an outer diameter C of 1.5 cm. FIG. 9 depicts the marker sleeve 10 in a relaxed state after marking and cold shrinking, as described in FIG. 1, without the cable 12. Referring to the dimensional labels depicted in FIG. 2, the marker sleeve 10 in FIG. 9 has a longitudinal length A of 6.5 cm, an inner diameter B of 1.3 cm, and an outer diameter C of 1.5 cm. FIGS. 7-9 further illustrate retraction of the indicia 20 as the marker sleeve 10 cold shrinks. The indicia 20 in the expanded state are taller and narrower than the indicia 20 in the relaxed state. However, when the marker sleeve 10 is in the relaxed state, the indicia 20 remains visually legible to an unaided eye of an individual with 20/20 vision located at least about 36 cm (about 14 inches) away from the indicia.

### Suitable Materials for Marker Sleeve

Examples of suitable elastomers include vulcanized elastomers, thermoplastic elastomers, thermoset elastomers, terpolymers of an ethylene-propylene-diene monomer (EPDM) (referred to herein as “EPDM rubbers”), silicone elastomers, fluoroelastomers, fluorosilicone elastomers, and combinations thereof. Examples of particularly suitable elastomers include EPDM rubbers, which exhibit good resistance to heat, ozone, oxidation, weathering, and polar solvents. Examples of suitable diene termonomers used to form the EPDM rubbers include ethylidene norbornene and dicyclopentadiene.

Examples of suitable pigments include titanium dioxide; carbon black; zinc oxide; pression blue; cadimum sulfide; iron oxide; chromates of lead, zinc, barium, and calcium; azo; thioindigo; anthraquinone; anthoanthrone; triphenonedioxazine; fat dye pigments; phthalocyanine pigments, such as copper phthalocyanine pigment and its derivatives; quinacridon pigment; pigments commercially available under the trade designations “Cinquasia”, “Cromophtal”, “Filamid”, “Filester”, “Filofin”, “Hornachrome”, “Horna Molybdate”, “Homatherm”, “Irgacolor”, “Irgalite”, “Irgasperse”, “Irgazin”, “Micranyl”, “Microlen”, “Microlith”, “Microsol”, and “Unisperse”, all from Ciba Specialty Chemicals of Tarrytown, N.Y.; and combinations thereof. The color and concentration of pigment(s) incorporated may depend upon the energy beam absorber incorporated. A suitable example to provide a high contrast is a yellow-color pigment in combination with an energy beam absorber that chars the outer surface 16 of the marker sleeve 10 when heated by a focused energy beam (i.e., form a dark-colored indicia 20 on a light-colored outer surface 16).

Examples of suitable energy beam absorbers include PolyOne Material No. AD 3000051160 (“Stan-Tone MB-27838 Black”), PolyOne Material Product No. CC10041306WE, both available from PolyOne Corporation of Suwanee, Ga.; RTP Material No. RTP 0299×102892 SSL-801191, available from RTP Company of Winona, Minn.; Clariant Material No. 00025275, available from Clariant Masterbatches Division of Albion, Mich.; Ticona Material No. 1000-2LM ND3650, available from Ticona of Summit, N.J.; BASF Material No. NPP TN020327 (“Ultramid B3K LS Black 23189”), available from BASF Corporation Performance Polymers of Mt. Olive, N.J.; and combinations thereof. These materials may include titanium dioxide, mica, and combinations thereof. Titanium dioxide may function as a pigment and an energy beam absorber, as discussed in Birmingham, Jr. et al., U.S. Pat. No. 5,560,845, which is incorporated herein by reference in its entirety.

The compositional mixture used to form the marker sleeve 10 may also include additional materials such as antioxidants, oils, processing aids, neutralizers, rheology modifiers, fillers, silane coupling agents, cross-linking agents, and acrylic co-agents.

Examples of suitable antioxidants include solutions of zinc 2-mercaptotoluimidazole in petroleum process oil (e.g., “Vanox ZMTI” and “Vanox MTI”) and mixtures of octylated diphenylamines (e.g. “Agerite Stalite”), all commercially available from R. T. Vanderbilt Company, Inc. of Norwalk, Conn.; and combinations thereof. Suitable concentrations of the antioxidants in the compositional mixture of the marker sleeve 10 range from about 0.1% to about 5.0%, with particularly suitable concentrations of the antioxidants in the compositional mixture of the marker sleeve 10 ranging from about 0.5% to about 1.5%, based on the total weight of the compositional mixture of the marker sleeve 10.

Examples of suitable oils include hydrocarbon oils, mineral oils, pine oils, paraffinic petroleum oils, oleic acid, glycerol, polypropylene glycols, polybutylene glycols, and combinations thereof. Suitable concentrations of the oils in the compositional mixture used to form the marker sleeve 10 range from about 5.0% to about 40.0%, with particularly suitable concentrations of the oils in the compositional mixture of the marker sleeve 10 ranging from about 10.0% to about 25.0%, based on the total weight of the compositional mixture of the marker sleeve 10.

Examples of suitable processing aids include the following, which are commercially available from Struktol Company of America of Stow, Ohio: Mixtures of fatty acid metal (e.g., zinc) soaps and amides (e.g., “Struktol A 50”, “Struktol A 60”, “Struktol A 61”, “Struktol EF 44 A”, and “Struktol WB 42”); mixtures of rubber compatible non-hardening fatty acid soaps (e.g., “Struktol EP 52”); fatty acid esters and soaps-bound fillers (e.g., “Struktol W 34” and “Struktol” WB 212”); mixtures of lubricants and fatty acid derivatives (e.g., “Struktol W 80”); mixtures of esters and zinc soaps of fatty acids (e.g., “Struktol WA 48”); mixtures of fatty acid soaps, predominantly calcium (e.g., “Struktol WB 16”); mixtures aliphatic fatty acid esters and condensation products (e.g., “Struktol WB 222”); condensation products of fatty acid derivatives and silicones (e.g., “Struktol WS 180”); organosilicone compounds on inorganic carriers (e.g., “Struktol WS 280”); and combinations thereof. Suitable concentrations of the processing aids in the compositional mixture of the marker sleeve 10 range from about 0.1% to about 10.0%, with particularly suitable concentrations of the processing aids in the compositional mixture of the marker sleeve 10 ranging from about 0.5% to about 2.0%, based on the total weight of the compositional mixture of the marker sleeve 10.

Fillers may be incorporated in the compositional mixture of the marker sleeve 10 to enhance physical and rheological properties of both the pre-cross-linked compositional mixture and the marker sleeve 10. Examples of suitable fillers include clay fillers, hydrated amorphous silica, precipitated silica, fumed silica, fired silica, hydrophobized silica, derivatives thereof, and combinations thereof. Examples of suitable clay fillers include silane treated kaolin clay (aluminum silicate) fillers commercially available from Engelhard Corporation of Iselin, N.J., under the trade designations “Translink 37”, “Translink 77”, “Translink 445”, “Translink 555”, and “Translink HF-900”. Suitable concentrations of the fillers in the compositional mixture of the marker sleeve 10 range from about 1.0% to about 50.0%, with particularly suitable concentrations of the fillers in the compositional mixture of the marker sleeve 10 ranging from about 10.0% to about 25.0%, based on the total weight of the compositional mixture of the marker sleeve 10.

Silane coupling agents assist in bonding the fillers to the polymers of the compositional mixture of the marker sleeve 10. Examples of suitable silane coupling agents include vinyl silanes (e.g., “A-172 DLC”), methacryl silanes (e.g., “A-174 DLC”), amino silanes (e.g., “A-1100 DLC” and “A-1120”), all commercially available from Natrochem, Inc. of Savannah, Ga.; liquid tetrasulfide silanes (e.g., “Silquest A-1289”), liquid disulfide silanes (e.g., “Silquest A-1589”), both commercially available from OSI Specialties Division of Witco Corporation of Danbury, Conn.; and combinations thereof. Suitable concentrations of the silane coupling agents in the compositional mixture of the marker sleeve 10 range from about 0.1% to about 5.0%, with particularly suitable concentrations of the silane coupling agents in the compositional mixture of the marker sleeve 10 ranging from about 0.1% to about 1.0%, based on the total weight of the compositional mixture of the marker sleeve 10.

Examples of suitable cross-linking agents include amines and peroxides, such as the following peroxides that are commercially available from R. T. Vanderbilt Company, Inc. of Norwalk, Conn.: Dicumyl peroxide (e.g., “Varox DCP”, “Varox DCP-40C”, “Varox DCP-40KE”, and “Varox DCP-40KE-HP”); benzoyl peroxide (e.g., “Varox ANS”); dibenzoyl peroxide (e.g., “Varox A 75”); 2,5-dimethyl-2,5-di(t-butylperoxy)hexane (e.g., “Varox DBPH”, “Varox DBPH 40 MB”, “Varox DBPH-50”, “Varox DBPH-50-HP”, “Varox DBPH-P20”, and “Varox DCP-40KE”); t-butyl perbenzoate (e.g., “Varox TBPB” and “Varox TBPB-50”); 2,5-dimethyl-2,5-di(t-butylperoxy)hexyne-3 (e.g., “Varox 130” and “Varox 130-XL”); alpha, alpha-bis(t-butylperoxy)diisopropylbenzene (e.g., “Varox VC-R”); di-(2-tert-butylperoxyisopropyl)benzene (e.g., “Varox 802-40C”, “Varox 802-40KE”, and “Varox 802-40KE-HP”); di-(2-tert-butylperoxyisopropyl)benzene in EPR (e.g., “Varox 802-40MB”); derivatives thereof; and combinations thereof. Suitable concentrations of the cross-linking agents in the compositional mixture of the marker sleeve 10 range from about 0.5% to about 5.0%, with particularly suitable concentrations of the cross-linking agents in the compositional mixture of the marker sleeve 10 ranging from about 1.0% to about 3.0%, based on the total compositional weight of the composition of the present invention.

Acrylic co-agents may be incorporated into the compositional mixture of the marker sleeve 10 to enhance the cross-linking reaction. Examples of suitable acrylic co-agents include multi-functional monomers, such as difunctional and trifunctional monomers. Examples of suitable difunctional monomers include the following, which are commercially available from Sartomer Company, Inc., Exton, Pa.: 1,3-butylene glycol diacrylate, 1,3-butylene glycol dimethacrylate, 1,4-butanediol diacrylate, 1,4-butanediol dimethacrylate, 1,6 hexanediol diacrylate, 1,6 hexanediol dimethacrylate, aliphatic dimethacrylate monomer, alkoxylated aliphatic diacrylate, alkoxylated cyclohexane dimethanol diacrylate, alkoxylated cyclohexane dimethanol diacrylate, alkoxylated cyclohexane dimethanol diacrylate, alkoxylated hexanediol diacrylate, alkoxylated hexanediol diacrylate, alkoxylated hexanediol diacrylate, alkoxylated neopentyl glycol diacrylate, alkoxylated neopentyl glycol diacrylate, aromatic dimethacrylate monomer, caprolactione modified neopentylglycol hydroxypivalate diacrylate, caprolactone modified neopentylglycol hydroxypivalate diacrylate, cyclohexane dimethanol diacrylate, cyclohexane dimethanol dimethacrylate, diethylene glycol diacrylate, diethylene glycol dimethacrylate, dipropylene glycol diacrylate, ethoxylated(10)bisphenol alpha diacrylate, ethoxylated(2)bisphenol alpha dimethacrylate, ethoxylated(3)bisphenol alpha diacrylate, ethoxylated(30)bisphenol alpha diacrylate, ethoxylated(30)bisphenol alpha dimethacrylate, ethoxylated(4)bisphenol alpha diacrylate, ethoxylated(4)bisphenol alpha dimethacrylate, ethoxylated(8)bisphenol alpha dimethacrylate, ethoxylated bisphenol alpha dimethacrylate, ethoxylated bisphenol alpha dimethacrylate, ethoxylated(10)bisphenol dimethacrylate, ethoxylated(6)bisphenol alpha dimethacrylate, ethylene glycol dimethacrylate, hydroxypivalaldehyde modified trimethylolpropane diacrylate, neopentyl glycol diacrylate, neopentyl glycol dimethacrylate, polyethylene glycol(200)diacrylate, polyethylene glycol(400)diacrylate, polyethylene glycol(400)dimethacrylate, polyethylene glycol(600)diacrylate, polyethylene glycol(600)dimethacrylate, polyethylene glycol dimethacrylate, polypropylene glycol(400)dimethacrylate, propoxylated(2)neopentyl glycol diacrylate, tetraethylene glycol diacrylate, tetraethylene glycol dimethacrylate, tricyclodecane dimethanol diacrylate, triethylene glycol diacrylate, triethylene glycol dimethacrylate, tripropylene glycol diacrylate, tripropylene glycol diacrylate, and combinations thereof.

Suitable concentrations of the acrylic co-agents in the compositional mixture of the marker sleeve 10 range from about 0.1% to about 5.0%, with particularly suitable concentrations of the acrylic co-agents in the compositional mixture of the marker sleeve 10 ranging from about 0.5% to about 2.0%, based on the total weight of the compositional mixture of the marker sleeve 10.

The present invention may also include flame retardants, flame retardant synergists, and antimicrobials, as disclosed in the co-pending patent application filed on even date (attorney docket 59595US002), entitled “NBC-Resistant Composition”.

The compositional mixture used to form the marker sleeve 10 may be prepared by combining the elastomer, the pigment, and the energy beam absorber, and then mixing these components in a 10D 2-wing tangential Banbury mixer with a 220 liter capacity at about 50 rotations-per-minute for about 4-8 minutes at temperature of about 141° C. The Banbury mixer is commercially available from Farrel Corporation of Ansonia, Conn. The compositional mixture may then be passed through a 25.4-cm extruder equipped with a 100 mesh screen to remove undispersed particles.

Additional materials such as antioxidants, oils, processing aids, neutralizers, rheology modifiers, fillers, and silane coupling agents, may also be added with the elastomer, the pigment, and the energy beam absorber prior to mixing. However, if cross-linking agents or acrylic co-agents are to be incorporated in the compositional mixture, the addition of these components should be in a second mixing step at a lower temperature to prevent premature cross linking. After the elastomer, the pigment, and the energy beam absorber, and most other of the additional materials have been combined, mixed, and passed through the mesh screen, the cross-linking agents and acrylic co-agents may be added and the overall compositional mixture may be mixed in a 10D 2-wing tangential Banbury mixer with a 220 liter capacity at about 45 rotations-per-minute for about 1.5-3 minutes at temperature of about 102° C.

The compositional mixture may be extruded to form a pre-cross-linked tubular article. A suitable extruder includes a 5.1-cm single-screw extruder with a length-to-diameter ratio of about 15. Suitable operation conditions for the extruder include extruder zone temperatures and a die temperature of about 80° C., and a rotation rate of about 20 to about 40 rotations-per-minute. This provides for a material flow rate of about three to about twelve meters-per-minute. Particular pins and dies will dictate inner diameters and layer thicknesses of the tubular article prior to crosslinking that yields the marker sleeve 10.

Upon exiting the extruder, the tubular article may be passed through an autoclave to crosslink the components of the compositional mixture and form the marker sleeve 10. Suitable autoclave conditions include subjecting the tubular article to a steam pressure of about 620 kilopascals for about 45 minutes, which is equivalent to exposure to a temperature of about 166° C. at atompshereic pressure for about 45 minutes.

Property Analysis and Charaterization Procedures

Various analytical techniques are available for characterizing the sealant materials of the present invention. Several of the analytical techniques are employed herein. An explanation of these analytical techniques follows.

### Laser Marking Test

The visual legibility of the indicia was qualitatively determined for marker sleeves pursuant to the following procedure. A marker sleeve without indicia, having a 1.0 mm outer diameter, was expanded onto a core with a 2.0 cm diameter. The expanded marker sleeve was then laser marked to form indicia by a Nd:YAG laser system. The Nd:YAG laser system was commercially availably under the trade name “Hi-Mark” No. 400 from GSI Lumonics, Inc. of Kanata, Ontario, Canada. The laser settings for the Nd:YAG laser system included a power setting of 64.8 watts, a rate of marking 5.1 cm/minute, and a frequency of 6 wave peaks per second. The set distance of the laser system head to the outer surface of the marker sleeve was 18.3 cm (7.2 inches). The indicia were marked so that, in the relaxed state, the indicia exhibited a type-face height in a circumferential direction of the marker sleeve of 2.0 mm.

After marking, the marker sleeve was removed from the core and allowed to substantially cold shrink back toward the relaxed state. The indicia on the marker sleeve substantially in the relaxed state were then visually observed by an unaided human eye. The marking was determined to be acceptable if the indicia (exhibiting a type-face height of 2.0 mm) on the marker sleeve were visually legible by an unaided human eye (i.e., about 20/20 vision) from a distance of at least about 36 cm (about 14 inches).

### Physical Property Tests

Physical properties regarding the tension modulus (100%, 200%, and 300%), tensile strength at break, percent elongation at break, shore A hardness, and percent permanent set of the composition of the present invention were quantitatively measured to illustrate the elasticity and durability of articles formed from the composition of the present invention. The tension modulus (100%, 200%, and 300%), tensile strength at break, and percent elongation at break tests were performed pursuant to ASTM D412-92. The shore A hardness test was performed pursuant to ASTM D2240-03.

The percent permanent set test illustrates the amount of elastic recovery a material exhibits. For different compositional mixtures of the marker sleeve, a dogbone sample was formed with an ASTM D412-92 Die C Dumbbell Cutter, with an original length of 2.54 cm. The sample was then placed in a tension set fixture and stretched longitudinally to 200% of the original length (i.e., 100% strain). This length (i.e., 5.08 cm) was recorded as the test length. The stretched sample was then retained in the stretched dimension and subjected to a temperature of 100° C. for three hours. The stretched sample was then cooled for one hour at a temperature of 21° C. After cooling, the stretched sample was removed from the tension set fixture allowed to cold shrink for 30 minutes at room temperature. The relaxed length was then measured. The percent permanent set was calculated by the following equation:

$$\% PermanentSet = \frac{100 \times ( RelaxedLength - OriginalLength )}{( TestLength - OriginalLength )}$$

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from general chemical suppliers such as the Sigma-Aldrich Chemical Company of Saint Louis, Mo., or may be synthesized by conventional techniques.

The following compositional abbreviations are used in the following Examples:
“Buna EPT 6850”: A terpolymer of an ethylene-propylene-diene monomer, commercially available from Bayer Chemical Corporation of Leverkusen, Germany.
“Buna EPT 8902”: An oil-extended 50% terpolymer of an ethylene-propylene-diene monomer, commercially available from Bayer Chemical Corporation of Leverkusen, Germany.
“FE Polymer 2524”: A fluoroelastomer polymer, commercially available under the trade designation “Dyneon 2524” from 3M Corporation of St. Paul, Minn.
“Vanox ZMTI”: An antioxidant derived from a 50% dispersion of zinc 2-mercaptotoluimidazole in a petroleum process oil, commercially available from R. T. Vanderbilt Company, Inc. of Norwalk, Conn.
“Stantone MB Yellow”: A 50% dispersion of an azoic pigment CI pigment yellow 83 in ethylene-propylene rubber, commercially available under the trade designation “Stantone MB 11070 Yellow” from PolyOne Corporation of Suwanee, Ga.
“Stanton DB Yellow”: A dry-blend yellow pigment, commercially available under the trade designation “Stantone DB 29282 Yellow” from PolyOne Corporation of Suwanee, Ga.
“Struktol EF-44 A”: A processing aid mixture of a fatty acid metal soap and an amide, commercially available from Struktol Company of America of Stow, Ohio.
“Rheogran ZnO-85” A solution of 85% active zinc oxide dispersion in mineral oil, commercially available from Rhein Chemie Rheinau GmbH of Mannheim, Germany.
“Translink 37”: Silane treated kaolin clay (aluminum silicate) with a particle size of 1.4 micrometers, commercially available from Engelhard Corporation of Iselin, N.J.
“Hisil 532 EP”: Hydrated amorphous silica filler commercially available from PPG Industries, Inc. of Pittsburgh, Pa.
“Saytex BT-93 W”: A flame retardant derived from 1,2 bis(tetrabromophthalimide)ethane, commercially available from Albemarle Corporation of Houston, Tex.
“Sunpar 2280”: A parafinnic petroleum oil commercially available from Sunoco, Inc. of Philadelphia, Pa.
“Zinc Omadine”: A fungicide solution of 65% 2-pyridinethiol-1-oxide, zinc complex in a paraffinic oil (i.e., Zinc Omadine), commercially available from Arch Chemicals, Inc. of Cheshire, Conn.
“Nycol Burn EX ZTA”: Sodium antimonite commercially available from Nyacol Nano Technologies, Inc. of Ashland, Mass.
“Tipure 902”: Titanium dioxide commercially available from E.I. Du Pont Corporation of Wilmington, Del.
“A-172 DLC”: A silane coupling agent derived from vinyl-tris(2-methoxyethoxy)silane, commercially available from Natrochem, Inc. of Savannah, Ga.
“PolyOne Material”: A laser additive derived from Stan-Tone MB-27838 Black, designated as “PolyOne Material # AD 3000051160”, available from PolyOne Corporation of Suwanee, Ga.
“Varox 802-40KE”: A peroxide cross-linking agent derived from a solution of 40% active di(2-tert-butylperoxyisopropyl)benzene supported on a silane modified clay, commercially available from R. T. Vanderbilt Company, Inc. of Norwalk, Conn.
“SR-297 Methacrylate”: An acrylic co-agent derived from 1,3 butyleneglycol-dimethacrylate, commercially available under the trade designation “SR-297” from Sartomer Company, Inc. of Exton, Pa.
“Elastomag 170”: Magnesium oxide commercially available from Rohm and Haas of North Andover, Mass.
“Calcium Hydroxide”: Calcium hydroxide commercially available from Sigma-Aldrich Chemical Company of Saint Louis, Mo.
“Halocarbon-95 Oil”: An oligomer of chlorotrifluoroethylene commercially available from Halocarbon Products Corporation of River Edge, N.J.

### Example 1

Example 1 concerns a marker sleeve of the present invention. The component concentrations of the compositional mixture used to form the Example 1 marker sleeve are provided in Table 1. The compositional mixture of the marker sleeve of Example 1 was prepared by combining the components provided in Table 1 (except the Varox 802-40KE peroxide and the SR-297 methacrylate) in a first mixing step, and then mixing these components in a 10D 2-wing tangential Banbury mixer with a 220 liter capacity at 50 rotations-per-minute for eight minutes at a temperature of 141° C. The compositional mixture was then passed through a 25.4-cm extruder equipped with a 100 mesh screen to remove undispersed particles.

The Varox 802-40KE peroxide and the SR-297 methacrylate were then added in a second mixing step and the overall compositional mixture was mixed in a 10D 2-wing tangential Banbury mixer with a 220 liter capacity at about 45 rotations-per-minute for 3 minutes at a temperature of 102° C.

The marker sleeve of Example 1 was formed from the compositional mixture by extruding the compositional mixture through a 5.1-cm single-screw extruder having a length-to-diameter ratio of 15, extruder zone and die temperatures of 80° C., and a rotation rate of 30 rotations-per-minute. Upon exiting the extruder, the marker sleeve was cross linked by passing the extruded article through an autoclave, having a steam pressure of 620 kilopascals, for 45 minutes.

TABLE 1

| Component | Percent by Weight * |
|---|---|
| Buna EPT 6850 | 27.3 |
| Buna EPT 8902 | 23.4 |
| Vanox ZMTI | 0.8 |
| Stantone MB Yellow | 2.3 |
| Struktol EF-44 A | 0.8 |
| Rheogran ZnO-85 | 1.6 |
| Translink 37 | 7.8 |
| Hisil 532 EP | 15.6 |
| Sunpar 2280 | 15.6 |
| A-172 DLC | 0.4 |
| PolyOne Material | 0.1 |
| Varox 802-40KE | 2.7 |
| SR-297 Methacrylate | 1.5 |

* Based on the total weight of the compositional mixture of Example 1.

### Example 2

Example 2 concerns a marker sleeve of Example 1, which additionally includes Saytex BT-93 W flame retardant, Zinc Omadine fungicide, and Nycol Burn EX ZTA flame retardant synergist in the compositional mixture (added in the first mixing step). Table 2 provides the component concentrations of the compositional mixture used to form the marker sleeve of Example 2. The marker sleeve of Example 2 was formed from the compositional mixture of Example 2 pursuant to the procedure described for the marker sleeve of Example 1.

TABLE 2

| Component | Percent by Weight * |
|---|---|
| Buna EPT 6850 | 22.4 |
| Buna EPT 8902 | 19.2 |
| Vanox ZMTI | 0.6 |
| Stantone MB Yellow | 1.9 |
| Struktol EF-44 A | 0.6 |
| Rheogran ZnO-85 | 1.3 |
| Translink 37 | 6.4 |
| Hisil 532 EP | 12.8 |
| Saytex BT-93 W | 15.4 |
| Sunpar 2280 | 12.8 |
| Zinc Omadine | 0.2 |
| Nycol Burn EX ZTA | 2.6 |
| A-172 DLC | 0.3 |
| PolyOne Material | 0.1 |
| Varox 802-40KE | 2.2 |
| SR 297 Methacrylate | 1.2 |

* Based on the total weight of the compositional mixture of Example 2.

### Example 3

Example 3 concerns a marker sleeve of Example 2, which additionally includes Tipure 902 titanium dioxide in the compositional mixture (added in the first mixing step). Table 3 provides the component concentrations of the compositional mixture used to form the marker sleeve of Example 3. The marker sleeve of Example 3 was formed from the compositional mixture of Example 3 pursuant to the procedure described for the marker sleeve of Example 1.

TABLE 3

| Component | Percent by Weight * |
|---|---|
| Buna EPT 6850 | 21.7 |
| Buna EPT 8902 | 18.6 |
| Vanox ZMTI | 0.6 |
| Stantone MB Yellow | 1.9 |
| Struktol EF-44 A | 0.6 |
| Rheogran ZnO-85 | 1.2 |
| Translink 37 | 6.2 |
| Hisil 532 EP | 12.4 |
| Saytex BT-93 W | 14.9 |
| Sunpar 2280 | 12.4 |
| Zinc Omadine | 0.2 |
| Nycol Burn EX ZTA | 2.5 |
| Tipure 902 | 3.1 |
| A-172 DLC | 0.3 |
| PolyOne Material | 0.1 |
| Varox 802-40KE | 2.2 |
| SR-297 Methacrylate | 1.2 |

* Based on the total weight of the compositional mixture of Example 3.

### Example 4

Example 4 concerns a marker sleeve of Example 3, but does not include the PolyOne Material energy beam absorber in the compositional mixture. Table 4 provides the component concentrations of the compositional mixture used to form the marker sleeve of Example 4. The marker sleeve of Example 4 was formed from the compositional mixture of Example 4 pursuant to the procedure described for the marker sleeve of Example 1.

TABLE 4

| Component | Percent by Weight * |
|---|---|
| Buna EPT 6850 | 21.7 |
| Buna EPT 8902 | 18.6 |
| Vanox ZMTI | 0.6 |
| Stantone MB Yellow | 1.9 |
| Structol EF-44 A | 0.6 |
| Rheogran ZnO-85 | 1.2 |
| Translink 37 | 6.2 |
| Hisil 532 EP | 12.4 |
| Saytex BT-93 W | 14.9 |
| Sunpar 2280 | 12.4 |
| Zinc Omadine | 0.2 |
| Nycol Burn EX ZTA | 2.5 |
| Tipure 902 | 3.1 |
| A-172 DLC | 0.3 |
| Varox 802- 40KE | 2.2 |
| SR 297 Methacrylate | 1.2 |

* Based on the total weight of the compositional mixture of Example 4.

### Example 5

Example 5 concerns a marker sleeve incorporating a fluoroelastomer. Table 5 provides the component concentrations of the compositional mixture used to form the marker sleeve of Example 5. The compositional mixture of the marker sleeve of Example 5 was prepared by mixing the components provided in Table 5 with an HBI System 90 mixer with a Rheomix 3000E mixing head, both commercially available from Haake Buchler Instruments, Fort Lee, N.J., at 60° C. for eight minutes. The marker sleeve of Example 5 was formed from the compositional mixture of this Example 5 pursuant to the procedure described for the marker sleeve of Example 1.

TABLE 5

| Component | Percent by Weight * |
|---|---|
| FE polymer 2524 | 68.0 |
| Stanton DB 29282 Yellow | 2.0 |
| Elastomag 170 | 2.0 |
| Calcium Hydroxide | 4.1 |
| Halocarbon-95 Oil | 6.8 |
| PolyOne Material | 0.1 |
| Hisil 532 EP | 17.0 |

* Based on the total weight of the compositional mixture of Example 5.

### Laser Marking Test for Examples 1-5

The marker sleeves of Examples 1-5 were tested according to the “Laser Marking Test” procedure described above, with the exception that laser system marked the marker sleeve of Example 5 with a power setting of 55.8 watts instead of 64.8 watts. After the marker sleeves of Examples 1-5 had substantially cold shrunk back toward the relaxed state, the indicia on each of the marker sleeves remained visually legible to an unaided human eye from at least 36 cm (about 14 inches). This illustrates the benefit of marking the indicia on the marker sleeves of the present invention in an expanded state pursuant to the present invention. When marking the indicia while the marker sleeve is in an expanded state, a higher degree of detail and resolution of the indicia is obtained, which thereby reduces the marking precision required to produce the indicia. The resulting indicia remains visually legible when the marker sleeve 10 substantially cold shrinks to the relaxed state.

### Physical Property Tests for Examples 1-4

The marker sleeves of Examples 1-4 were tested pursuant to the “Physical Properties Tests” procedures described above. Table 6 provides the results of the physical property tests for the marker sleeves of Examples 1-4. The tension modulus (100%, 200%, and 300%) and tensile strength at break have metric units of megaNewton per square meter (MN/m²) (i.e., 1×10⁶ Newtons per square meter).

TABLE 6

| | Example | Example | Example | Example |
|---|---|---|---|---|
| Physical Property | 1 | 2 | 3 | 4 |
| 100% Modulus (MN/m²) | 0.87 | 1.05 | 1.21 | 1.13 |
| 200% Modulus (MN/m²) | 1.45 | 1.59 | 1.91 | 1.74 |
| 300% Modulus (MN/m²) | 2.01 | 2.11 | 2.48 | 2.31 |
| Tensile Strength at | 4.30 | 5.13 | 6.20 | 6.14 |
| Break (MN/m²) | | | | |
| % Elongation at | 627 | 715 | 732 | 717 |
| Break | | | | |
| Shore A Hardness | 48 | 50 | 52 | 52 |
| % Permanent Set | 9.8 | 16.0 | 16.5 | 16.2 |

The data provided in Table 6 illustrates the expansion capabilities and durability of the marker sleeves of Examples 1-4. The marker sleeves of Examples 1-4 exhibited 100% tension moduli from 0.87 MN/m² to 1.21 MN/m², 200% tension moduli from 1.45 MN/m² to 1.91 MN/m², and 300% tension moduli from 2.01 MN/m² to 2.48 MN/m². The marker sleeves of Examples 1-4 exhibited tensile strengths at break from 4.30 MN/m² to 6.20 MN/m² with percent elongations at break from 627% to 732%. The marker sleeves of Examples 1-4 also exhibited shore A hardnesses of about 50.

The marker sleeves of Examples 1-4 also exhibited percent permanent sets from about 10% to about 16%. As such, when subjected to the percent permanent set test, as described above, the marker sleeves of Examples 1-4 are capable of cold shrinking back about 84% to about 90% from the expanded state dimensions.

### Marker Sleeve Sizing and Expansion for Example 3

The compositional mixture of Example 3 was extruded and cross linked to form marker sleeves with varying inner diameters and layer thicknesses (Examples 3a-3g). Table 7 provides the inner diameters, layer thicknesses, outer diameters, and longitudinal lengths for the marker sleeves of Examples 3a-3g, which respectively correspond to the inner diameter B, layer thickness D, outer diameter C, and longitudinal length A of the marker sleeve 10, depicted in FIG. 2.

TABLE 7

| | Inner | Layer | Outer | |
|---|---|---|---|---|
| Marker | Diameter | Thickness | Diameter | Longitudinal |
| Sleeve | (mm) | (mm) | (mm) | Length (mm) |
| Example 3a | 6.1 | 1.5 | 9.1 | 34.3 |
| Example 3b | 8.1 | 1.5 | 11.2 | 34.3 |
| Example 3c | 10.2 | 1.9 | 14.0 | 34.3 |
| Example 3d | 13.2 | 1.9 | 17.0 | 34.3 |
| Example 3e | 16.5 | 1.9 | 20.3 | 34.3 |
| Example 3f | 20.3 | 1.9 | 24.1 | 34.3 |
| Example 3g | 22.4 | 1.9 | 26.2 | 34.3 |

The marker sleeves of Examples 3a-3g were expanded and placed onto cores, as depicted in FIG. 3. Table 8 provides the core diameter, the percent expansion of the inner diameter of the marker sleeves of Examples 3a-3g, and the minimum and maximum cable diameters for use with the marker sleeves of Examples 3a-3g.

TABLE 8

| | | | Minimum | Maximum |
|---|---|---|---|---|
| | Core | | Cable | Cable |
| Marker | Diameter | % | Diameter | Diameter |
| Sleeve | (mm) | Expansion | (mm) | (mm) |
| Example 3a | 17.3 | 229 | 9.0 | 14.3 |
| Example 3b | 26.4 | 259 | 12.5 | 23.5 |
| Example 3c | 31.8 | 240 | 15.3 | 28.8 |
| Example 3d | 43.7 | 252 | 20.2 | 40.7 |
| Example 3e | 53.8 | 251 | 25.2 | 49.3 |
| Example 3f | 66.0 | 245 | 30.7 | 61.4 |
| Example 3g | 72.4 | 242 | 33.7 | 67.8 |

As the data in Table 8 illustrates, the marker sleeves of Examples 3a-3g were expanded from about 230% to about 260%. This range of expansion is suitable for marking the marker sleeves of Examples 3a-3g in the expanded state. While, the data provided in Table 8 are for the marker sleeve of Example 3 with a longitudinal length of 34.2 mm, similar results were obtained for the marker sleeve of Example 3 with a longitudinal length of 88.9 mm.

The cable diameters are suitable minimum and maximum diameters for cables (i.e., cable 12) that the marker sleeves of Examples 3a-3g may extend around when removed from the cores after marking. The minimum diameters are determined by an 18% permanent set of the marker sleeves. That is, the minimum cable diameters provided in Table 8 are the inner diameters (i.e., inner diameter B) of the marker sleeves of Examples 3a-3g, with the assumption of a 15% loss of elasticity. Referring to Table 6, the marker sleeve of Example 3 exhibits about a 16.5% permanent set. As such, the minimum cable diameters provided in Table 8 provide suitable minimum values to prevent the marker sleeves of Examples 3a-3g from sliding along the corresponding cables.

Although the present invention has been described with reference to preferred embodiments, workers skilled in the art will recognize that changes may be made in form and detail without departing from the spirit and scope of the invention.

1. A method comprising:
providing a tubular article, the tubular article comprising an elastomer and an energy beam absorber; then
expanding the tubular article from an unstretched relaxed state to a stretched expanded state; then
forming indicia on the outer surface of the tubular article with a focused energy beam when the tubular article is in the stretched expanded state; and then
allowing the tubular article to cold shrink from the stretched expanded state to the unstretched relaxed state.

2. The method of claim 1, wherein providing the tubular article comprises extruding and cross-linking a mixture that comprises the elastomer and the energy beam absorber to form the tubular article.

3. The method of claim 1, wherein the focused energy beam comprises a laser beam.

4. The method of claim 3, wherein forming the indicia comprises charring a select portion of the outer surface of the tubular article.

5. The method of claim 3, wherein forming the indicia comprises foaming a select portion of the outer surface of the tubular article.

6. The method of claim 3, wherein the laser beam comprises a Nd:YAG laser beam.

7. The method of claim 1, wherein expanding the tubular article comprises expanding a diameter of the tubular article from an unstretched diameter in the unstretched relaxed state to a stretched diameter in the stretched expanded state that is in the range of about 150% to about 300% greater than the unstretched diameter in the unstretched relaxed state.

8. The method of claim 1, further comprising exhibiting in the tubular article a percent elongation at break of at least 600% when tested pursuant to ASTM D412.

9. The method of claim 1, further comprising exhibiting in the indicia a legibility to an unaided eye of an individual with 20/20 vision located at least about 36 centimeters away from the indicia when the tubular article is in the stretched expanded state and when the tubular article is in the unstretched relaxed state.

10. A method comprising:
providing a tubular article, the tubular article comprising an elastomer and an energy beam absorber; then
expanding the tubular article from an unstretched relaxed state to a stretched expanded state; and then
forming indicia on the outer surface of the tubular article with a focused energy beam when the tubular article is in the stretched expanded state.

11. The method of claim 10, wherein providing the tubular article comprises extruding and cross-linking a mixture that comprises the elastomer and the energy beam absorber to form the tubular article.

12. The method of claim 10, wherein the focused energy beam comprises a laser beam.

13. The method of claim 12, wherein forming the indicia comprises charring a select portion of the outer surface of the tubular article.

14. The method of claim 12, wherein forming the indicia comprises foaming a select portion of the outer surface of the tubular article.

15. The method of claim 12, wherein the laser beam comprises a Nd:YAG laser beam.

16. The method of claim 10, wherein expanding the tubular article comprises expanding a diameter of the tubular article from an unstretched diameter in the unstretched relaxed state to a stretched diameter in the stretched expanded state that is in the range of about 150% to about 300% greater than the unstretched diameter in the unstretched relaxed state.

17. The method of claim 10, further comprising exhibiting in the tubular article a percent elongation at break of at least 600% when tested pursuant to ASTM D412.

18. The method of claim 10, further comprising exhibiting in the indicia a legibility to an unaided eye of an individual with 20/20 vision located at least about 36 centimeters away from the indicia when the tubular article is in the stretched expanded state and when the tubular article is in the unstretched relaxed state.
